(19) United States
(12) Patent Application Publication
(10) Pub. No.: US 2025/0051121 A1
(43) Pub. Date: Feb. 13, 2025

(54) METHOD FOR SPLICING TWO FLEXIBLE ARTICLES, AND SPLICING MODULE FOR IMPLEMENTING THE METHOD

(71) Applicant: SPOOLEX, Roche la Moliere (FR)

(72) Inventor: Luc Lassalle, Saint-Etienne (FR)

(21) Appl. No.: 18/720,556

(22) PCT Filed: Oct. 13, 2022
(86) PCT No.: PCT/FR2022/051932

§ 371 Date: Jun. 14, 2024

(30) Foreign Application Priority Data
Dec. 17, 2021 (FR) FR2113918

(51) Int. Cl. B65H 19/10; B65H 19/12

(52) U.S. Cl. CPC B65H 19/102; B65H 19/12; B65H 2301/4607; B65H 2301/46172; B65H 2301/4622; B65H 2301/46314; B65H 2406/34

(57) ABSTRACT

The invention relates to a method for automatically splicing a first article, unwound from a first reel, to a second article wound around a second reel, the articles being flexible and in the form of webs or strips. According to the invention, the method comprises steps consisting in: positioning an adhesive tape on an end that is to be spliced belonging to the second article; automatically moving a portion of the first article to a cutting plane situated facing the end that is to be spliced belonging to the second article; holding the portion of the first article downstream of the cutting plane with respect to the first reel; cutting the first article transversely; automatically moving the end that is to be spliced belonging to the second article as far as the cutting plane; and pressing a cut end of the first article at the cutting plane against the end that is to be spliced belonging to the second article in order to stick them together using the adhesive tape.

### TECHNICAL FIELD

The invention relates to the technical field of unwinding/winding reels of flexible articles, such as fabric webs or layers for example, and relates to a method for splicing two flexible articles with adhesive tape. The invention also relates to a splicing module for implementing said method.

The invention has an advantageous application for manufacturers or users of textile machines, implementing fabric reeling reels, for example. Indeed, when a reeling reel is empty, it is necessary to replace it with a new reel, while preserving the continuity of the fabric by splicing the final end of the empty reel, with the initial end of the new reel.

### PRIOR ART

Splicing with adhesive tape is a technique which is well-known to a person skilled in the art, which consists in particular in making two webs or layers of a flexible material integral.

This technique is carried out manually, with the disadvantages arising from this.

In particular, the operator is limited to working in a confined space, and to putting their hands in the middle of a cutting and splicing station, which is not safe.

Document WO2015/097364 in the name of the applicant is known, which describes a splicing method and module, but which does not relate to the technique of splicing with adhesive tape.

Document FR3010397 is also known, which describes a module for splicing with adhesive tape, but which does not describe the way in which this module could be integrated in an automatic splicing method and at industrial speeds.

### SUMMARY OF THE INVENTION

One of the aims of the invention is to provide a splicing method and module, which are automatic, rapid with an optimal efficiency, and which are safer and more ergonomic for operators.

Another aim of the invention is to provide a splicing method and module capable of continuously performing several splicing cycles.

Finally, the invention aims to provide such a method and such a module offering the option to choose its type of splicing by cold lamination, between for example, overlapping or end-to-end splicing.

To this end, a method for automatically splicing a first article unwound from a first reel with a second article wound around a second reel has been developed, the articles being flexible and in the form of webs or strips.

According to the invention, the method comprises steps consisting in:
positioning an adhesive tape on an end that is to be spliced belonging to the second article;
automatically moving a portion of the first article to a cutting plane situated facing the end that is to be spliced belonging to the second article;
holding the portion of the first article downstream of the cutting plane with respect to the first reel;
cutting the first article transversally;
automatically moving the end that is to be spliced belonging to the second article as far as the cutting plane;
pressing a cut end of the first article held at the cutting plane against the end that is to be spliced belonging to the second article in order to stick them together using the adhesive tape.

In this way, the method according to the invention makes it possible to optimally, rapidly and automatically splice two flexible articles. This method therefore makes it possible to increase the splicing efficiency. Indeed, while the first article is unwound, the supply of a second reel, the step of moving a portion of the first article to a cutting plane, and the positioning of the adhesive tape on an end that is to be spliced belonging to the second article, can be done in concurrent operation time, on the unwinding of the first article.

The unwinding of the first article is stopped only when it becomes necessary to perform the cutting of said first article at the splicing plane. After this operation, the two articles are put in contact and taped. After these relatively short operations, the unwinding is immediately restarted.

In order to further optimise the efficiency, when the first article is cut transversally, the reel of the first article is discharged automatically and replaced automatically by a new, full one, and in concurrent operation time with respect to the unwinding of the second reel.

The invention also relates to a splicing module, provided to equip an installation for continuously unwinding reels of flexible articles.

The module enables the automatic splicing of a first article unwound from a first reel with a second article wound around a second reel, the articles being flexible and in the form of webs or strips.

According to the invention, the module comprises:
first means for moving a portion of the first article to a cutting plane;
means for holding the first article downstream of the cutting plane with respect to the first reel;
a cutting carriage which is movable transversally in the cutting plane;
two support means which are movable in the direction of one another, to press the articles that are to be spliced on either of the cutting plane, the support means comprising attachment means of an end that is to be spliced belonging to the second article and/or to an adhesive tape;
an adhesive tape positioned on an end that is to be spliced belonging to the second article.

The module thus comprises all the features enabling it to implement the splicing method described, and has the same advantages.

According to particular embodiments:
the means for holding the first article downstream of the cutting plane are in the form of a clamp;
the attachment means are in the form of suction means.

Advantageously, the module comprises second means for moving a portion, positioned to move in the cutting plane, a portion of the second article unwound from the second reel.

In this way, the method implemented makes it possible to continuously perform several splicing cycles. Indeed, the method is reversible, since the splicing plane wherein, or at the level of which the portions that are to be spliced are moved, is offset from the unwinding path of the installation. This feature makes it possible to leave the unwinding of the first or of the second article free, by implementing means for automatically moving a portion of each article that is to be spliced in the splicing plane. The method is thus reversible. More specifically, when the second reel is empty, this becomes the first reeling reel, and it is sufficient to repeat the steps of the method to perform the splicing with another second reel.

According to a particular embodiment, the first or second movement means are in the form of a workflow roll which is movable in the cutting plane.

Advantageously, the cutting carriage is also longitudinally movable in the cutting plane, so as to be able to adjust the transversal cutting height to, as a function of the type of splicing chosen, splice by overlapping or end-to-end.

Preferably, and always with the aim of improving the efficiency and of making the method safer for operators, the module comprises means for automatically discharging and supplying reels.

### BRIEF DESCRIPTION OF THE DRAWINGS

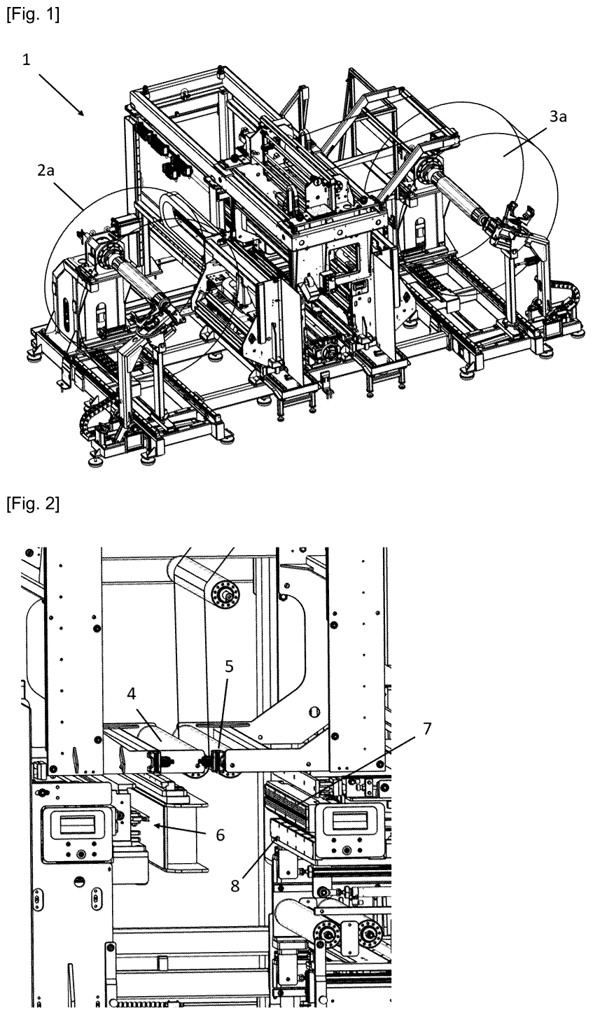

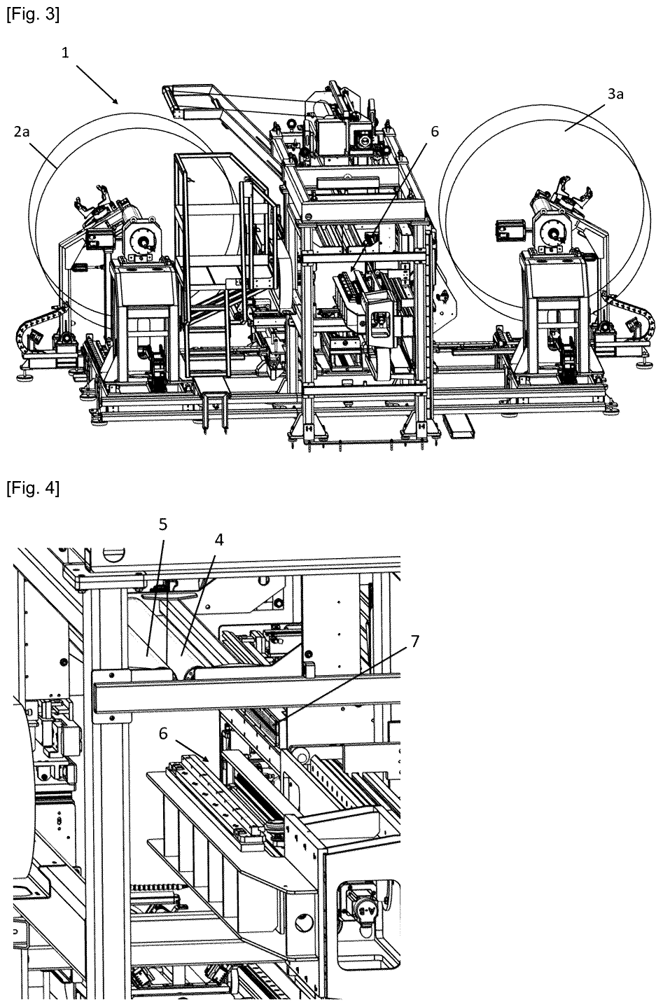

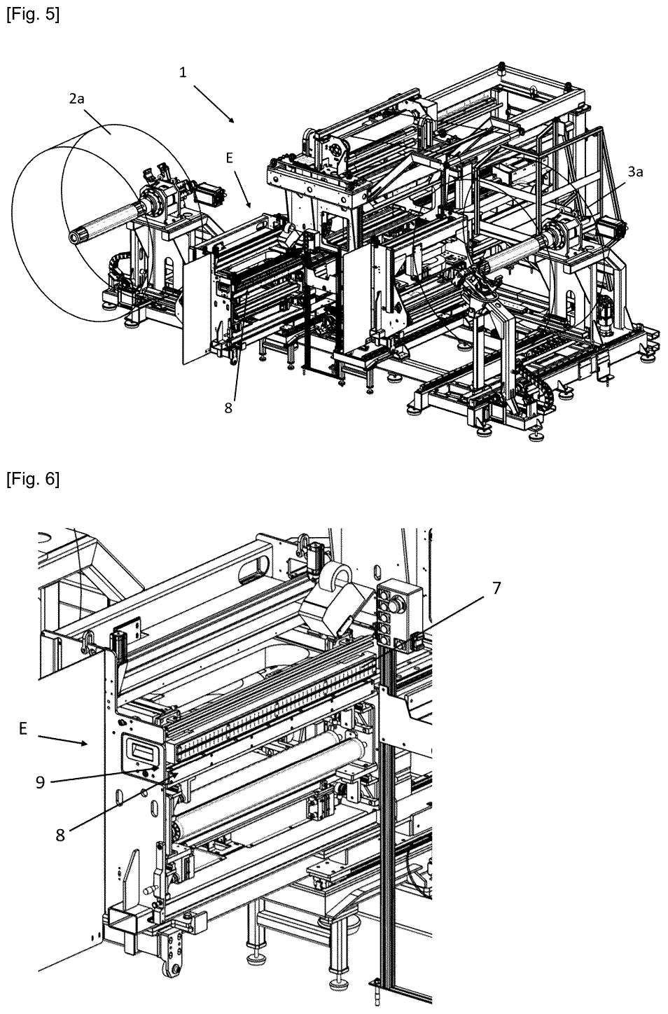

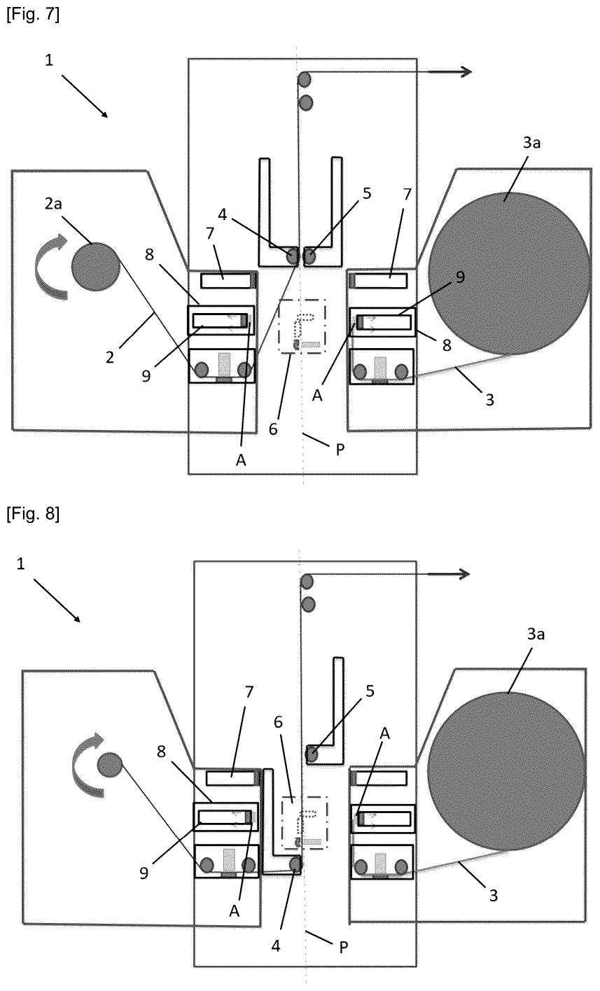

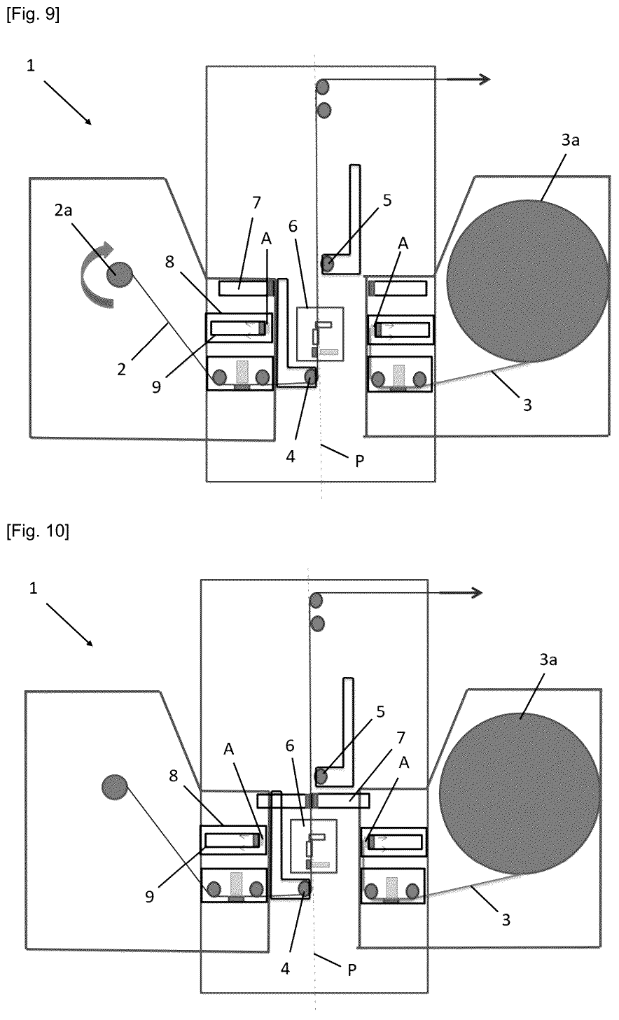

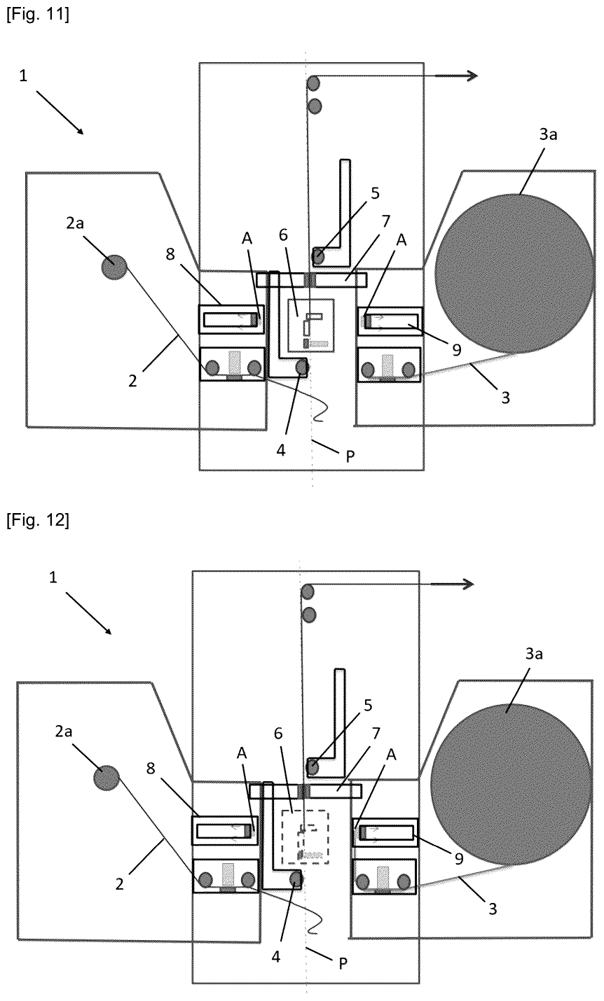

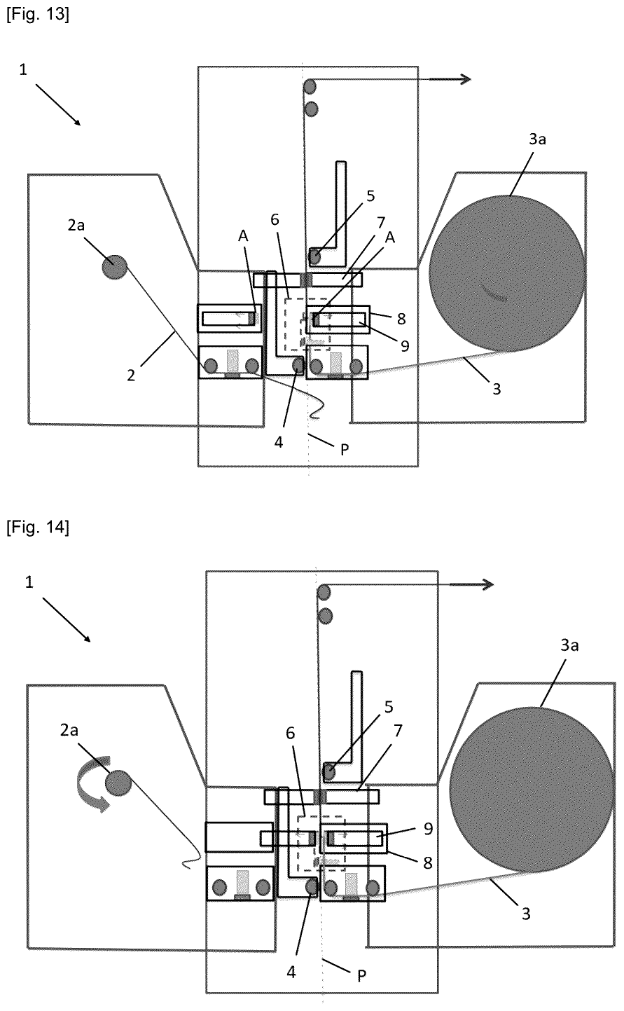

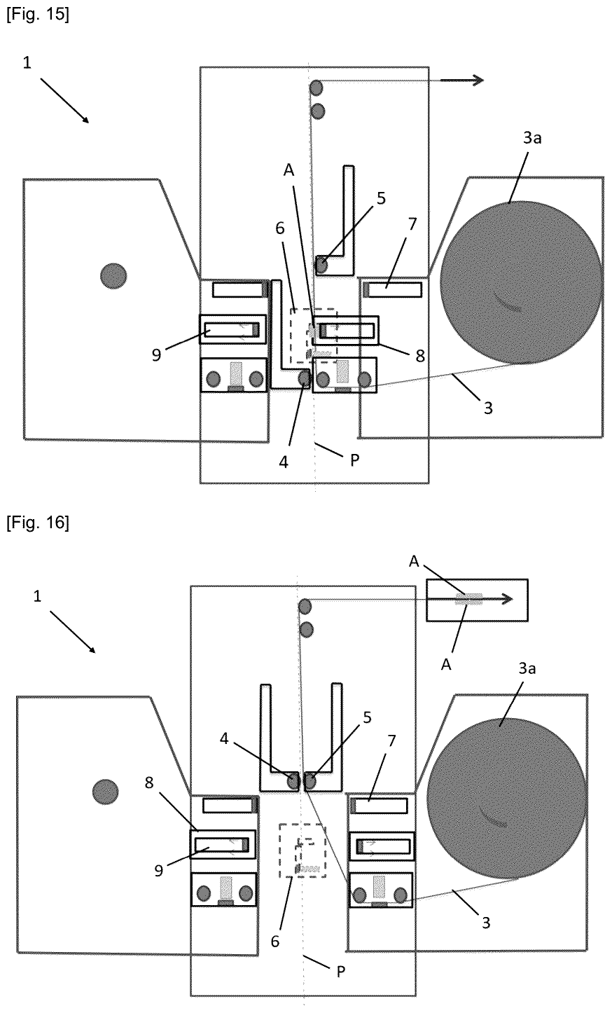

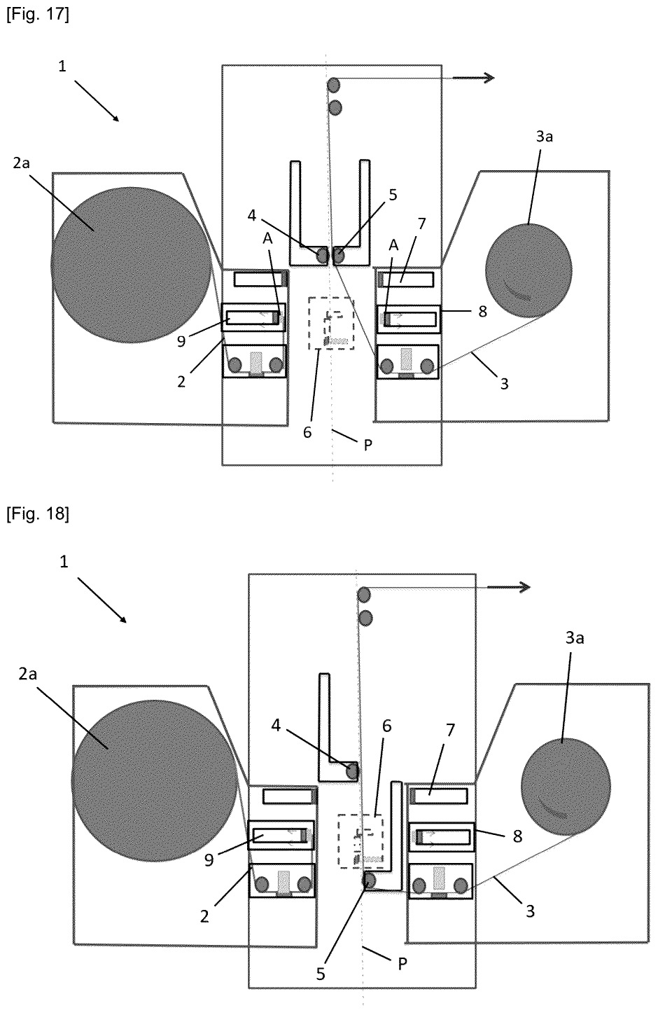

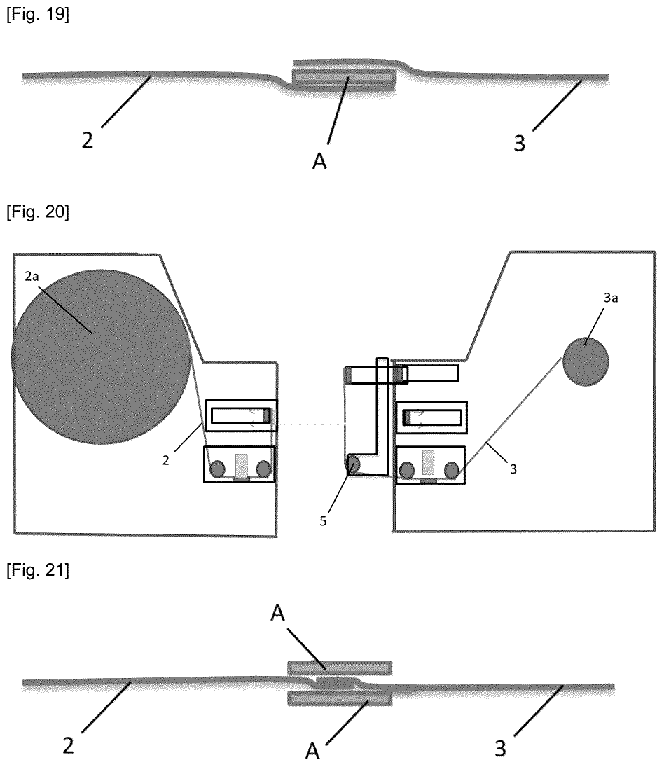

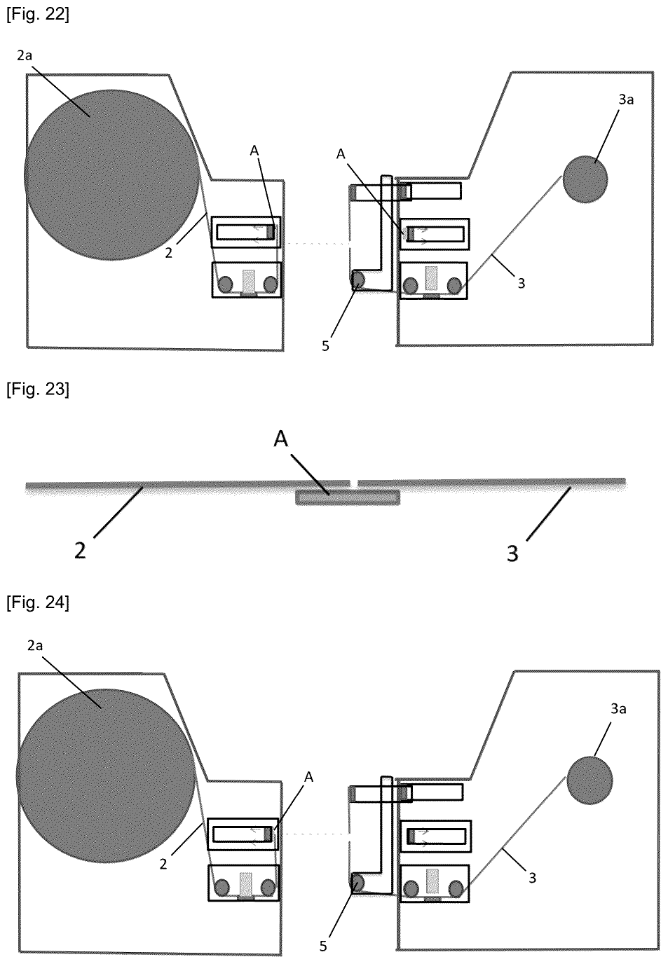

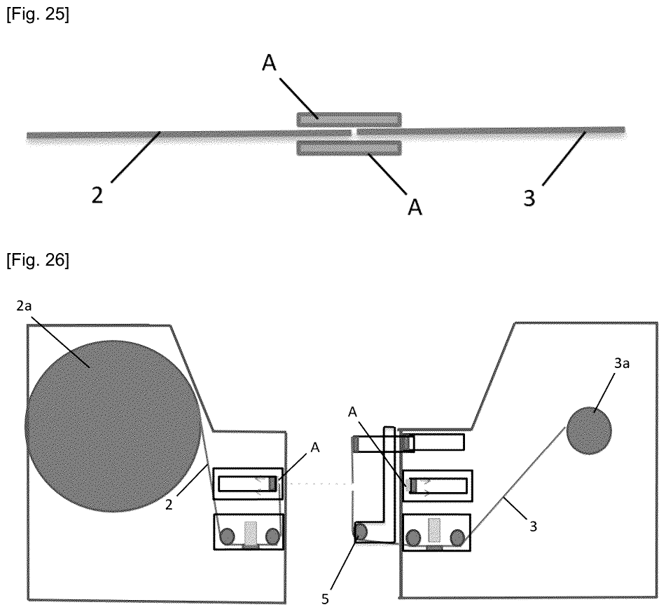

Other features and advantages of the invention will clearly emerge from the description below, for information and in a not-at-all limiting manner, in reference to the accompanying figures, wherein:

[FIG. 1] illustrates, as a perspective, front view, a splicing module, according to the invention.

[FIG. 2] is a detailed view at a cutting plane.

[FIG. 3] is a perspective, rear view of the splicing module.

[FIG. 4] illustrates in detail, from behind, the transverse cutting carriage.

[FIG. 5] is a view similar to that of FIG. 1, illustrating the attachment means and the support means in an offset position of the module.

[FIG. 6] is a view similar to that of FIG. 5, in detail on the support and attachment means.

[FIG. 7] is a schematic representation of the splicing module and representing a step of unwinding a first article from a first reel, and supplying a second article wound around a second reel.

[FIG. 8] illustrates the automatic movement of a portion of the first article to the cutting plane.

[FIG. 9] illustrates the transverse movement of the cutting chariot in the cutting plane.

[FIG. 10] illustrates the holding of the portion of the first article downstream of the cutting plane with respect to the first reel.

[FIG. 11] illustrates the transverse cutting of the first article.

[FIG. 12] illustrates the removal of the transverse cutting carriage.

[FIG. 13] illustrates the automatic movement of the end that is to be spliced belonging to the second article to the cutting plane.

[FIG. 14] illustrates the compression of a cut end of the first article against the end that is to be spliced belonging to the second article to perform the splicing operation as such.

[FIG. 15] illustrates the removal of the holding means, as well as the removal of the first support means.

[FIG. 16] illustrates the removal of the second support means, and the unwinding of the second article.

[FIG. 17] illustrates the supply of a new first reel and the holding of an end that is to be spliced belonging to the first article.

[FIG. 18] illustrates the reversibility of the method with the reel of the second empty article, and the movement of a portion of the second article to the cutting plane.

[FIG. 19] shows a splicing of the overlapping type with double-sided adhesive tape.

[FIG. 20] represents the position of the double-sided adhesive tape and the adjustment of the transverse cutting height to obtain the overlapping splicing illustrated in FIG. 19.

[FIG. 21] shows a splicing of the overlapping type with two single-sided adhesive tapes.

[FIG. 22] represents the positioning of the single-sided adhesive tapes and the adjustment of the transverse cutting height to obtain the overlapping splicing illustrated in FIG. 21.

[FIG. 23] illustrates a splicing of the end-to-end type with a single-sided adhesive tape.

[FIG. 24] illustrates the positioning of the single-sides adhesive tape and the transverse cutting height to hold the end-to-end splicing illustrated in FIG. 23.

[FIG. 25] shows a splicing of the end-to-end type with two single-sided adhesive tapes.

[FIG. 26] illustrates the positioning of the two single-sided adhesive tapes and the transverse cutting height to obtain the end-to-end splicing illustrated in FIG. 26.

### DETAILED DESCRIPTION OF THE INVENTION

In reference to FIGS. 1 to 26, the invention relates to a method and an automatic splicing module (1), rapid with an optimal efficiency, while being safer and more ergonomic for operators.

The invention makes it possible to perform a splicing with adhesive tape of two flexible articles (2, 3), such as fabric webs or layers, for example.

In reference to FIGS. 1 and 2, the module (1) receives, in a known manner, a first reel (2a) of a first article (2), which is intended to be continuously unwound, for example, to be subsequently cut into a plurality of strips.

When this first reel (2a) is empty, it becomes necessary to cut the first article (2) transversally and to splice the unwound end, not connected to the first reel (2a), to an end of a second article (3) wound around a second reel (3a).

These operations must be carried out by taking the least time as possible, while being safe for operators.

To this end, the module (1) comprises first means (4) for moving a portion of the first article (2) to a cutting plane (P). These first movement means (4) are, for example, in the form of a workflow roll, see FIG. 2, movably mounted to cross the unwinding path of the first article (2), in order to move a taut portion of said first article (2).

As will be described below in the description, the module (1) comprises second means (5) for moving a portion, this time of the second article (3), when this will be continuously unwound. These second means (5) are, for example, also in the form of a workflow roll movably mounted to cross the unwinding path of the second article (3), in order to move a taut portion of said second article (3) in the cutting plane (P).

In order to cut the unwound article continuously transversally, the module (1) comprises a cutting carriage (6), which is movable transversally in the cutting plane (P), in order to perform the transverse cutting operation, as such. The cutting carriage (6) integrates, in a known manner, cutting means adapted to the nature of the article to be cut, for example a blade, a sonotrode, etc.

The module (1) also comprises means (7) for holding an article before the transverse cutting operation, for example in the form of clamps, positioned on either side of the cutting plane (P), and which are movable, one in the direction of the other, to clamp and hold the portion of the article to be cut in position. These holding means (7) are positioned downstream of the cutting plane (P) with respect to the unwound reel, so as to be positioned downstream of the transverse cut.

The module (1) also comprises two support means (8) positioned on either side of the cutting plane (P) and which are movable in the direction of one another, to clamp or press the articles that are to be spliced together, on either side of the cutting plane (P). Preferably, the support means (8) comprise means (9) for attaching an end that is to be spliced belonging to an awaiting article, such that the automatic movement of the support means (8) makes it possible to position said end that is to be spliced in the cutting plane (P).

In practice, an adhesive tape (A) is positioned on the end that is to be spliced belonging to the article, which is held by the attachment means (9) that the support means (8) comprise.

According to particular embodiments, the attachment means (9) can be suction means, such as suction turbines.

The attachment means (9) are present on the two support means (8), so as to enable the reversibility of the method.

Moreover, these attachment means (9) also make it possible to hold adhesive tapes (A) as a function of the splicing technique chosen, such as it will be explained below.

In order to be able to position the end of the article that is to be spliced in engagement with the attachment means (9), the support means (8) and the attachment means (9) forms a slidingly mounted assembly (E), like a drawer, to be offset from the splicing module (1), see FIGS. 5 and 6. The holding means (7) can also form part of the same assembly (E).

In this way, an operator can safely attach the end that is to be spliced belonging to the awaiting article, and position the adhesive tape (A) as a function of the splicing type that they choose. These operations can also be carried out automatically. For example, the attachment means (9) associated with the support means (8) can be presented in the form of a drawer for storing and distributing the adhesive tape (A).

Always in order to improve the efficiency and the safety of operators, the module (1) advantageously comprises means for automatically discharging and supplying reels, for example, in the form of a robotic handler.

The splicing method according to the invention will now be described in reference to schematic FIGS. 7 to 18, by noting that the references used in FIGS. 1 to 6, and reused in FIGS. 7 to 18, mean the same elements.

FIG. 7 illustrates the unwinding of a first article (2) from a first reel (2a) through the splicing module (1). With the first reel (2a) being on the point of ending, a second reel (3a) of a second article (3) has been supplied, the free end of which is held by the attachment means (9), which, in this case, are represented in the form of suction means. In practice, in the embodiment illustrated, the suction means suction the non-sticky side of the adhesive tape (A) and the end of the article that is to be spliced is stuck in the lower part of the adhesive tape (A). A clamp prevents the unwinding of the second reel (3a).

On the other side, a second adhesive tape (A) is held, by suction, by the attachment means (9) of the second support means (8), with the adhesive side facing the cutting plane (P).

FIG. 8 illustrates a step of automatically moving a portion of the first article (2) to the cutting plane (P) situated facing the end that is to be spliced belonging to the second article (3). This step can be carried out in concurrent operation time on the end of the unwinding of the first article (2), in order to not decrease the efficiency.

FIG. 9 illustrates the transverse movement of the transverse cutting carriage (6). Then, the means (7) for holding the first article (2) downstream of the cutting plane (P) are moved, towards one another, to clamp the portion of said first article (2), see FIG. 10.

According to FIG. 11, the cut itself is performed, and the transverse cutting carriage (6) is removed, see FIG. 12.

The attachment means (9) of the end that is to be spliced belonging to the second article (3), and therefore consecutively, the first support means (8) are then automatically moved to the cutting plane (P), see FIG. 13, and the second support means (8) are moved in the direction of the cutting plane (P) to press the two articles (2, 3) together, before performing the splicing, see FIG. 14.

As can be observed, the two adhesive tapes (A) stick the two articles (2, 3) together to splice them, by overlapping or end-to-end, as a function of the type chosen.

During this time, the falling of the first reel (2a) continues to be wound in view of being discharged.

The first support means (8) and the holding means (7) are removed, and the method for unwinding the second reel (3a) starts, see FIG. 15.

Then, the means for moving the first portion and the second support means (8) are removed, see FIG. 16 to leave space for the unwinding of the second article (3).

In concurrent operation time on the unwinding of the second article (3), and in reference to FIG. 17, a new first reel (2a) is supplied, and its free end is attached to the attachment means (9) of the first support means (8), by being associated with an adhesive tape (A). A clamp holds this position.

Always in concurrent operation time on the unwinding of the second article (3), a second adhesive tape (A) is positioned and held by the attachment means (9) of the second support means (8).

FIG. 18 is similar to FIG. 8, and illustrates the first step consisting in moving the portion of the second article (3) in the cutting plane (P), and shows well that the method is reversible. The following steps are combined with those of FIGS. 9 to 16.

Choosing the type of splicing resides in the positioning of the adhesive tape(s) (A), of the type of adhesive tape(s) (A), namely single-sided or double-sided, and of the adjustment of the transverse cutting height. The cutting carriage (6) is movable longitudinally in the cutting plane (P) in order to be able to adjust said cutting height, preferably automatically.

For example, in reference to FIG. 19, the adhesive tape (A) is a tape of a double-sided adhesive, and is positioned along a transverse edge of the end of the article that is to be spliced on a side facing the cutting plane (P), without exceeding the edge, such that the sticking of the first article (2) and of the second article (3) is performed overlapping.

FIG. 20 illustrates the cutting height which must be situated below the adhesive tape (A) to have an overlapping of the two articles (2, 3), and the positioning of the adhesive tape (A).

According to another example illustrated in FIG. 21, the cutting height is adjusted, such that the two articles (2, 3) overlap, and two single-sided adhesive tapes (A) are positioned to stick the articles together, on either side, by overlapping.

FIG. 22 illustrates the cutting height and the positioning of the single-sided adhesive tapes (A).

According to another example illustrated in FIG. 23, the splicing is performed end-to-end, with a single-sided adhesive tape (A) positioned to overlap the two articles (2, 3).

FIG. 24 illustrates the cutting height and the positioning of the single-sided adhesive tape (A).

FIG. 25 is similar to FIG. 24, except that two single-sided adhesive tapes (A) are positioned to stick together and overlap the articles positioned end-to-end on either side.

FIG. 26 illustrates the cutting height and the positioning of the single-sided adhesive tapes (A).

1. A method for automatically splicing a first article unwound from a first reel with a second article wound around a second reel, the first and the second articles being flexible and in a form of webs or strips, wherein the method comprises:
positioning an adhesive tape on an end that is to be spliced belonging to the second article;
automatically moving a portion of the first article to a cutting plane situated facing the end that is to be spliced belonging to the second article;
holding the portion of the first article downstream of the cutting plane with respect to a motion of the first reel;
cutting the first article transversally;
automatically moving the end that is to be spliced belonging to the second article to the cutting plane; and
pressing a cut end of the first article held at the cutting plane against the end that is to be spliced belonging to the second article to stick them together with the adhesive tape.

2. The method according to claim 1, wherein, when the first article is cut transversally, the first reel of the first article is discharged automatically and replaced automatically by a first full reel, in concurrent operation time with respect to an unwinding of the second reel.

3. A module for automatically splicing a first article unwound from a first reel with a second article wound around a second reel, the first and the second articles being flexible and in a form of webs or strips, the module comprising:
first means for moving a portion of the first article to a cutting plane;
means for holding the first article downstream of the cutting plane with respect to a motion of the first reel;
a cutting carriage which is movable transversally in the cutting plane;
two support means which are movable in the direction of each other to press, on either side of the cutting plane, the first and second articles together that are to be spliced, the two support means comprising attachment means for an end that is to be spliced belonging to the second article and/or for an adhesive tape; and
the adhesive tape positioned on an end that is to be spliced belonging to the second article.

4. The module according to claim 3, wherein the means for holding the first article downstream of the cutting plane are in a form of a clamp.

5. The module according to claim 3, wherein the attachment means are in a form of suction means.

6. The module according to claim 3, further comprising second means configured for moving, in the cutting plane, a portion of the second article unwound from the second reel.

7. The module according to claim 3, wherein the first or second means for moving are in a form of a workflow roll which is movable in the cutting plane.

8. The module according to claim 3, wherein the cutting carriage is movable longitudinally in the cutting plane.

9. The module according to claim 3, further comprising means for automatically discharging and supplying reels.

10. The module according to claim 3, wherein the two support means and the attachment means form a sliding assembly mounted to the module, the sliding assembly configured to slide with respect to the module in a direction offset from the module.
